(19) United States
(12) Patent Application Publication
(10) Pub. No.: US 2008/0016779 A1
(43) Pub. Date: Jan. 24, 2008

(54) Seal and window clamp assembly

(75) Inventors: Balaji Ramanan, Bangalore (IN); Anil Jain, Farmington Hills, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/488,949

(22) Filed: Jul. 19, 2006

(51) Int. Cl. E05F 11/38

(52) U.S. Cl. 49/375

(57) ABSTRACT

A window clamp is used to hold a vehicle window within a vehicle door. The window clamp includes first and second clamp arms that are secured together with a fastener. A seal is inserted into a gap between first and second clamp arms. The seal includes first and second seal arms that engage both side surfaces of the vehicle window. The first and second clamp arms each include a slot. Portions of the seal are snapped into each slot to secure the seal to the window clamp.

### TECHNICAL FIELD

The subject invention relates to a seal and clamp assembly for holding a window in a vehicle door.

### BACKGROUND OF THE INVENTION

A window is moved between open and closed positions by a window regulator assembly that is mounted to a door module. The window is supported within a vehicle door by a clamp. The clamp is operably coupled to a movable component of the window regulator assembly. The clamp securely holds the window in place as the window regulator assembly moves the window between open and closed positions.

The clamp includes a pair of clamp arms that are separated from each other by a gap. A seal is received within this gap. The seal has a pair of seal arms that are connected to each other at a base portion and are separated from each other by an opening at their distal ends. An edge of the window is inserted into this opening and the clamp arms and seal arms grip opposing sides, i.e. both surfaces, of the window to hold the window in place.

Traditionally, the seal is wrapped around the clamp and is adhered to the clamp to prevent the seal from detaching during loading and unloading of the window. The application of an adhesive increases cost and adds additional operational steps.

Thus, there is a need for an improved window clamp and seal assembly, which can be securely held together without requiring adhesive.

### SUMMARY OF THE INVENTION

A window clamp is used to hold a vehicle window within a vehicle door. The window clamp includes first and second clamp arms that are spaced apart from each other at distal ends to form a gap. A seal is inserted into the gap and includes first and second seal arms that are adapted to engage both surfaces of the vehicle window. Portions of the seal are snapped into a slot in the window clamp to secure the seal to the window clamp.

In one example, the first and second clamp arms each include a slot, and the first and second seal arms each include an attachment feature. One attachment feature is snapped into each slot. In one example, the attachment feature comprises a base member that extends outwardly from each of the clamp arms to an enlarged head portion. The attachment feature is in an initial position prior to installation into the window clamp. The attachment feature is moved out of this initial position as the enlarged head portion is inserted into the slot. The attachment feature is resiliently biased to return to the initial position after insertion into the slot, which forms a snap-fit attachment that securely holds the seal to the window clamp.

The subject invention provides a snap-in seal that is easily secured to a window clamp without an adhesive, and which does not detach from the window clamp during loading and unloading of the vehicle window. These and other features of the present invention can be best understood from the following specification and drawings, the following of which is a brief description.

### BRIEF DESCRIPTION OF THE DRAWINGS

FIG. 1 is a perspective view of one example of a window clamp incorporating the subject invention.

FIG. 2 is a cross-sectional view of one example of a seal incorporating the subject invention.

FIG. 3 is a perspective view of the window clamp and seal of FIGS. 1-2 assembled together.

FIG. 4 is an end view of FIG. 3.

FIG. 5 is another example of a window clamp incorporating the subject invention.

FIG. 6 is another example of a seal incorporating the subject invention.

FIG. 7 is a perspective view of the window clamp and seal of FIGS. 5-6 assembled together.

### DETAILED DESCRIPTION OF THE PREFERRED EMBODIMENT

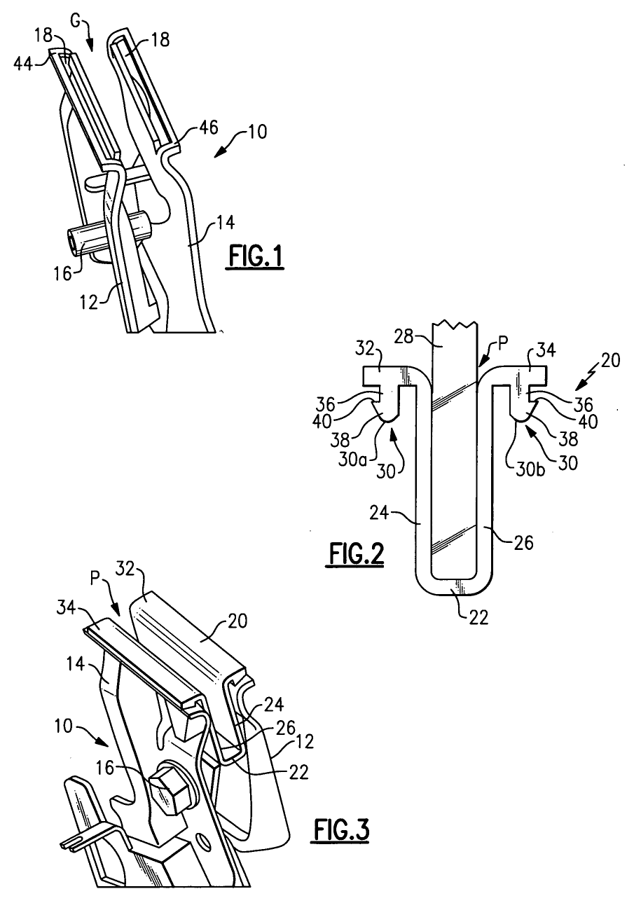

FIG. 1 shows an example of a window clamp 10 that includes a first clamp arm 12 and a second clamp arm 14. Lower portions of the first 12 and second 14 clamp arms are secured together with at least one fastener 16 as known. Upper portions of the first 12 and second 14 clamp arms are spaced apart from each other to provide a gap G. Each of the first 12 and second 14 clamp arms includes a slot 18.

A seal 20, shown in FIG. 2, is inserted into the gap G. The seal 20 is an extruded single-piece member that is cut to a desired length. The seal 20 can be made out of any type of resilient seal material. The seal 20 includes a base portion 22 and first 24 and second 26 seal arms that extend upwardly from the base portion 22. Upper portions of the first 24 and second 26 seal arms are spaced apart from each other to form a pocket P that receives a vehicle window 28. The first 24 and second 26 seal arms directly engage and seal against opposing sides of the vehicle window 28, i.e. both surfaces of the vehicle window 28 are engaged by the seal 20.

The clamp 10 and seal 20 cooperate to hold the vehicle window 28 within a vehicle door module. The clamp 10 is part of a window regulator assembly (not shown) that is used to move the vehicle window 28 between open and closed positions relative to a vehicle door (not shown). The clamp 10 and seal 20 can be used with any type of window regulator assembly.

As shown FIG. 2, the seal 20 includes at least one attachment feature 30. The attachment feature 30 comprises a snap-in seal portion that easily and effectively secures the seal 20 to the clamp 10 without requiring any additional attachments or operational steps, such as applying an adhesive. In the example shown in FIG. 2, each of the first 24 and second 26 seal arms includes one attachment feature 30.

The first seal arm 24 extends in a first direction and terminates at a first seal flange 32 that extends in a second direction transverse to the first direction. A first attachment feature 30a extends from the first seal flange 32 in a third direction that is transverse to the second direction. The second seal arm 26 extends in the first direction and terminates at a second seal flange 34 that extends in a direction opposite to the second direction, and which is transverse to the first direction. A second attachment feature 30b extends from the second seal flange 34 in the third direction.

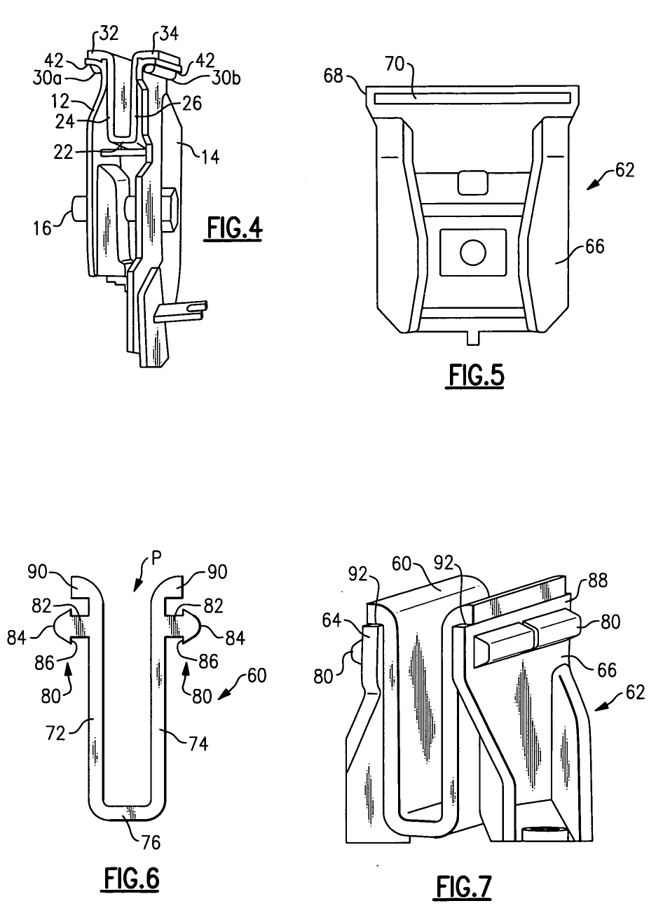

The first 30a and second 30b attachment features each comprises a base portion 36 that extends into an enlarged head portion 38. The enlarged head portion is defined by a maximum diameter that is greater than a width of the slots 18 in the first 12 and second 14 clamp arms. In the example shown in FIG. 2, the enlarged head portion 38 includes a gripping portion 40 that engages a clamp surface 42 (FIG. 4) when the seal 20 is installed in the clamp 10.

The first 12 and second 14 clamp arms extend in a first direction from ends that are secured with the fastener 16 to distal ends that are spaced to form the gap G. The first clamp arm 12 includes a first clamp flange 44 (FIG. 1) that extends in another direction transverse to the first direction. The second clamp arm 14 includes a second clamp flange 46 that extends in another direction transverse to the first direction. The first 44 and second 46 clamp flanges extend in opposing directions from each other.

In the example shown in FIGS. 1-4, the slots 18 are formed within the first 44 and second 46 clamp flanges. As shown in FIG. 3, the seal 20 is inserted into the gap G from the top. As shown in FIG. 4, the first 30a and second 30b attachment features are pushed downwardly and are snapped into the slots 18 in the first 44 and second 46 clamp flanges. During insertion, the attachment features 30a, 30b are moved from an initial position to a different position, and are resiliently biased to return to the initial position after insertion. Thus, the attachment features 30a, 30b form a secure snap-fit attachment.

FIGS. 5-7 show another example of a seal 60 that is snap fit to a clamp 62. This example is similar to that of FIGS. 1-4 except that the location of the slots in the clamp 62 is different, and the location and shape of the attachment features on the seal 60 is different.

As shown in FIGS. 5 and 7, the clamp 62 includes first 64 and second 66 clamp arms that operate similar to those described above. The first 64 and second 66 clamp arms extend upwardly in a first direction and terminate at distal ends 68 that do not include clamp flanges. Slots 70 are formed in each of the first 64 and second 66 clamp arms. The slots 70 extend along a width of the clamp arms.

The seal 60 is configured similarly to seal 20 described above, and includes first 72 and second 74 seal arms and a base portion 76 that cooperate to form a pocket P for receiving the vehicle window 28. An attachment feature 80 is formed in each of the first 72 and second 74 seal arms themselves, and not in seal flanges as in FIGS. 1-4. The seal arms 72, 74 extend upwardly from the base portion 76 in a first direction, and the attachment feature 80 extends outwardly in a direction transverse to the first direction.

Each attachment feature 80 is a snap-in member that includes a base portion 82 that extends into an enlarged head portion 84. The enlarged head portion 84 is defined by a maximum diameter that is greater than a width of the slots 70 in the first 64 and second 66 clamp arms. In the example shown in FIG. 6, the enlarged head portion 84 includes a gripping portion 86 that engages a clamp surface 88 (FIG. 7) when the seal 60 is installed in the clamp 62.

The seal 60 is inserted between the clamp arms 64, 66 from the top and the attachment features 80 are pushed outwardly into the slots 70. Transversely extending seal flanges 90 abut against upper edges 92 of the first 64 and second 66 clamp arms after installation.

In the configuration of FIGS. 5-7, the clamping area is slightly reduced for the clamp 62 due to the location of the slots 70. In the embodiment of FIGS. 1-4, by forming slots 18 in the clamp flanges, clamping area is not effected. Further, assembly may be facilitated with the configuration of FIGS. 1-4 as the insertion of the seal 20 and the insertion of the attachment features 30 are all occur in a common direction.

It should be understood that the orientation and shape of the attachment features could vary from the examples shown in FIGS. 1-7. Further, the location of the slots could also vary from the example locations shown in the figures.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A window clamp assembly comprising:
a clamp having a first clamp arm and a second clamp arm separated from each other by a gap, at least one of said first and said second clamp arms having a slot; and
a seal received within said gap for engaging opposing sides of a vehicle window, said seal including an attachment feature that is installed into said slot to secure said seal to said clamp.

2. The window clamp assembly according to claim 1 wherein each of said first and said second clamp arms includes a slot, and wherein said seal includes a first seal arm and a second seal arm with each of said first and second seal arms including said attachment feature with one attachment feature being inserted into each slot to secure said seal to said clamp

3. The window clamp assembly according to claim 2 wherein said attachment feature comprises a snap-in member that extends transversely to a respective one of said first and second seal arms.

4. The window clamp assembly according to claim 3 wherein said snap-in member has an initial position prior to installation into said clamp, and wherein said snap-in member is moveable out of said initial position during insertion into said slot, with said snap-in member being resiliently biased to return to said initial position after insertion into said slot.

5. The window clamp assembly according to claim 4 wherein said snap-in member includes a base extension that transitions into an enlarged head portion.

6. The window clamp assembly according to claim 5 wherein said enlarged head portion includes at least one gripping surface that directly engages a clamp surface.

7. The window clamp assembly according to claim 2 wherein said first clamp arm and said second clamp arm extend in a first direction, and wherein said slots are formed within said first and second clamp arms such that a length of said slots extends in a second direction transverse to said first direction.

8. The window clamp assembly according to claim 7 wherein said first clamp arm includes a first distal flange portion that extends transversely relative to said first direction and said second clamp arm includes a second distal flange portion that extends transversely relative to said first direction, and wherein said slots are formed within said first and said second distal flange portions.

9. A window clamp assembly comprising:
a first clamp arm;
a second clamp arm attached to said first clamp arm by at least one fastener, wherein distal ends of said first and said second clamp arms are separated from each other by a gap;
a first slot formed within said first clamp arm;
a second slot formed within said second clamp arm;
a seal received within said gap and including a base portion and first and second seal arms extending outwardly from opposing edges of said base portion and being spaced apart from each other at distal ends to form a pocket for receiving a vehicle window;
a first attachment feature extending outwardly from said first seal arm; and
a second attachment feature extending outwardly from said second seal arm, said first attachment feature being received within said first slot and said second attachment feature being received in said second slot such that said seal is fixed to said first and said second clamp arms.

10. The window clamp assembly according to claim 9 wherein said seal and said first and second attachment features are formed as a single piece component from an extruded material.

11. The window clamp assembly according to claim 9 wherein said first and said second attachment features each comprise a snap-in portion that grips at least one edge extending along each of said first and second slots to form a snap-fit attachment.

12. The window clamp assembly according to claim 9 wherein said first attachment feature comprises a first base extension extending outwardly from said first seal arm and a first enlarged head portion defined by a maximum diameter that is greater than a width of said first slot, and wherein said second attachment feature comprises a second base extension extending outwardly from said second seal arm and a second enlarged head portion defined by a maximum diameter that is greater than a width of said second slot.

13. The window clamp assembly according to claim 9 including a first flange portion extending transversely to said distal end of said first clamp arm and a second flange portion extending transversely to said distal end of said second clamp arm, said first and said second flange portions extending in opposite directions from each other, and wherein said first slot is formed within said first flange portion and said second slot is formed within said second flange portion.

14. A method of assembling a window clamp comprising the steps of:
(a) inserting a seal into a gap between first and second clamp arms; and
(b) snapping the seal into slots formed in the first and second clamp arms to fix the seal to the window clamp.

15. The method according to claim 14 including providing the seal with a first attachment feature on a first seal arm and a second attachment feature on a second seal arm and wherein step (b) includes snapping the first attachment feature into a first slot in the first clamp arm and snapping the second attachment feature into a second slot in the second clamp arm.

16. The method according to claim 15 including forming each of the first and second attachment features as a base member extending outwardly from a respective one of the first and second seal arms and an enlarged head portion.

17. The method according to claim 15 wherein step (b) includes moving the first and second attachment features from an initial position to a different position during insertion into the first and second slots and resiliently biasing the first and second attachment features such that the first and second attachment features return to the initial position after being inserted into the first and second slots.
